(19) United States
(12) Patent Application Publication
(10) Pub. No.: US 2013/0332621 A1
(43) Pub. Date: Dec. 12, 2013

(54) SYSTEM AND METHOD FOR COOPERATIVE DATA STREAMING

(71) Applicant: THE REGENTS OF THE UNIVERSITY OF CALIFORNIA, Oakland, CA (US)

(72) Inventors: Lorenzo Keller, Arbedo (CH); Minh Thoai Anh Le, Santa Ana, CA (US); Blerim Cici, Irvine, CA (US); Hulya Seferoglu, Chelsea, MA (US); Athina Markopoulou, Irvine, CA (US); Christina Fragouli, Lausanne (CH)

(73) Assignee: ECOLE POLYTECHNIQUE FEDERALE DE LAUSANNE (EPFL), Lausanne (CH)

(21) Appl. No.: 13/841,500

(22) Filed: Mar. 15, 2013

(30) Foreign Application Priority Data
Jun. 8, 2012 (EP) 12171382

(51) Int. Cl. H04L 29/06

(52) U.S. Cl. CPC H04L 65/60
USPC 709/231

(57) ABSTRACT

A system and method for cooperative data streaming are disclosed. According to one embodiment, a system for cooperative data streaming comprises a group of devices comprising at least two devices, which are interested in obtaining the same content from the same server. Each device comprises one or more primary network interfaces connecting the device to the data streaming service and one or more secondary network interfaces connecting the device to one or more of the other devices through one or more wireless local networks. The primary network interfaces are configured for connecting the devices to the data streaming service for receiving at least segments of data. The secondary network interfaces are configured for mutually connecting said devices in order to locally exchange said received segments of data.

The present application claims the benefit of and priority to E.P. Provisional Application No. EP12171382 titled “SYSTEM AND METHOD FOR COOPERATIVE DATA STREAMING,” filed on Jun. 7, 2012, which is hereby incorporated by reference in its entirety.

The present application is related to U.S. patent application Ser. No. 13/841,956, titled “System and Method for Local Multiplayer Gaming,” filed on Mar. 15, 2013, the disclosure of which is incorporated herein in its entirety.

### FIELD

The present disclosure relates generally to mobile device communications and, more particularly, to systems and methods that facilitate the cooperative data streaming.

### BACKGROUND

Smartphones and other mobile devices (including tablets) are equipped with significant processing, storage and sensing capabilities, as well as wireless connectivity through different network interfaces, including but not limited to cellular, WiFi, Bluetooth, ZigBee, NFC, etc. They provide ubiquitous Internet access, primarily through their cellular connection and secondarily through WiFi, and enable a plethora of new applications. Among those applications, video (including consuming and creating or posting video content) is increasingly popular. However, meeting the growing demand for high quality video is currently a challenge in cellular networks.

Cellular traffic is growing exponentially (tripling every year), with a share of video traffic increasing from 50% now to an expected 66% by 2015.23% of base stations globally have utilization rates of more than 80 to 85% in busy hours, up from 20% in 2011. This dramatic increase in demand poses a challenge for 3G networks, which is likely to remain in 4G networks as well. The data rate of the cellular connection may fluctuate over time (e.g. throughout the day); the service loss rate can be as high as 50%; and coverage can be spotty depending on the location and user mobility.

High-definition multimedia content consumed by mobile devices is among the most bandwidth intensive applications. Furthermore, real-time or popular videos are often requested by groups of users in proximity of each other at roughly the same time, which puts further strain on the network infrastructure. Examples of large groups watching the same video at the same place and time include the following: sport fans in a stadium who want to watch instant replays; emergency situations where FEMA wants to broadcast information; and live music events, conferences, trade shows, etc. Examples of smaller groups include teenagers who want to watch music video clip on YouTube with friends; or a group of friends who want to watch a live soccer match together on their phones while at a remote location; or a family who wants to watch a movie on their phones in a train or in a car. As the wireless Internet coverage expands, more and more people are watching video together on their mobile devices. According to a recent market study by Google, 50% of male YouTube viewers, who are between 18 and 34 years of age, watch YouTube video clips together with friends in person.

### SUMMARY

A system and method for cooperative data streaming are disclosed. According to one embodiment, a system for cooperative data streaming comprises a group of devices comprising at least two devices, which are interested in obtaining the same content (e.g. video) from a server. Each device comprises one or more primary network interfaces connecting the device to the data streaming service and one or more secondary network interfaces connecting the device to one or more of the other devices through one or more wireless local networks. The primary network interfaces are configured for connecting the devices to the data streaming service for receiving at least segments of data in stream mode. The secondary network interfaces are configured for mutually connecting said devices in order to locally exchange said received segments of data.

The systems, methods, features and advantages of the invention will be or will become apparent to one with skill in the art upon examination of the following figures and detailed description. It is intended that all such additional methods, features and advantages be included within this description, be within the scope of the invention, and be protected by the accompanying claims. It is also intended that the invention is not limited to require the details of the example embodiments.

### BRIEF DESCRIPTION

The accompanying drawings, which are included as part of the present specification, illustrate the presently preferred embodiment and, together with the general description given above and the detailed description of the preferred embodiment given below, serve to explain and teach the principles of the present invention.

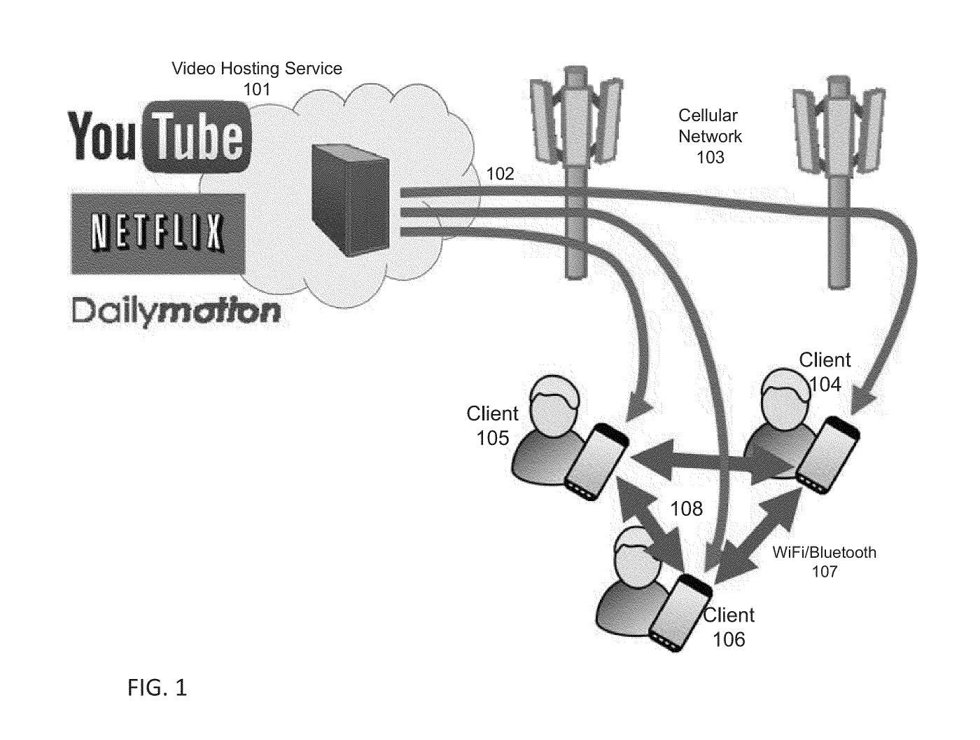

FIG. 1 illustrates an exemplary system level scenario for use with the present system, according to one embodiment.

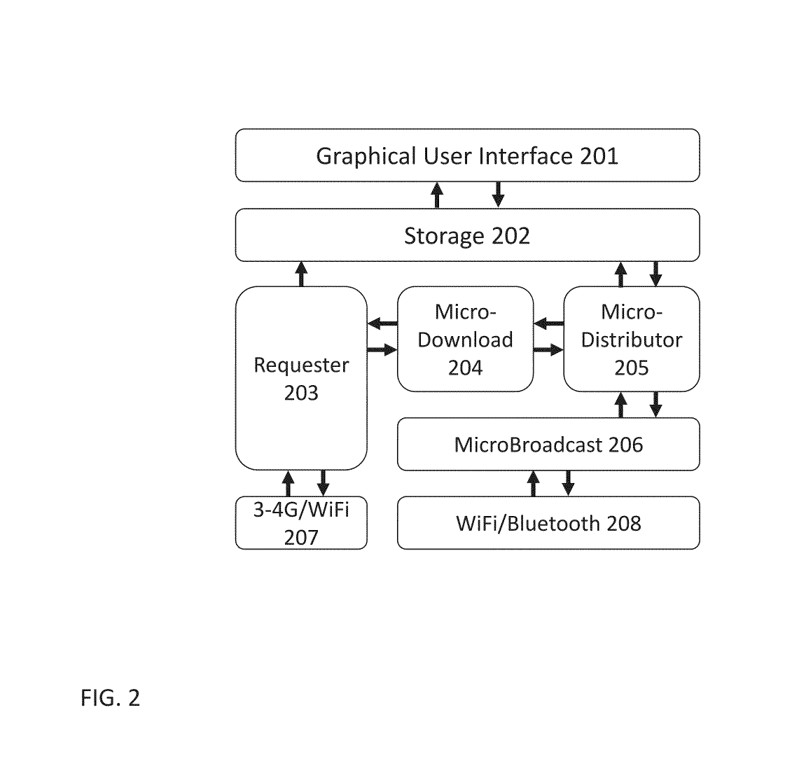

FIG. 2 illustrates an exemplary architecture for use with the present system, according to one embodiment.

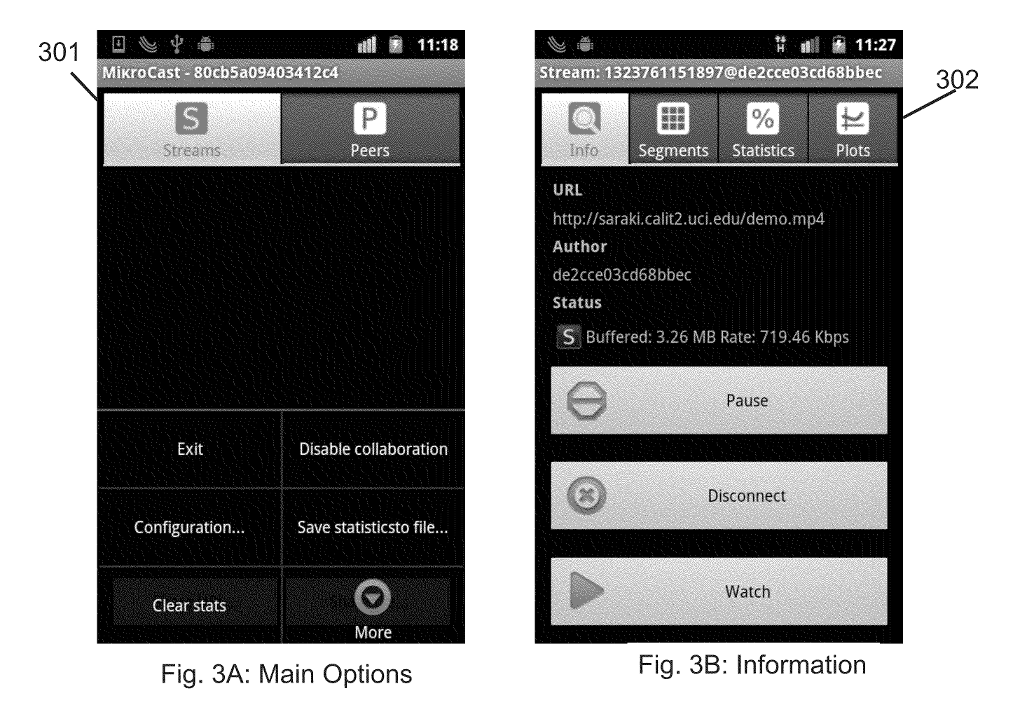

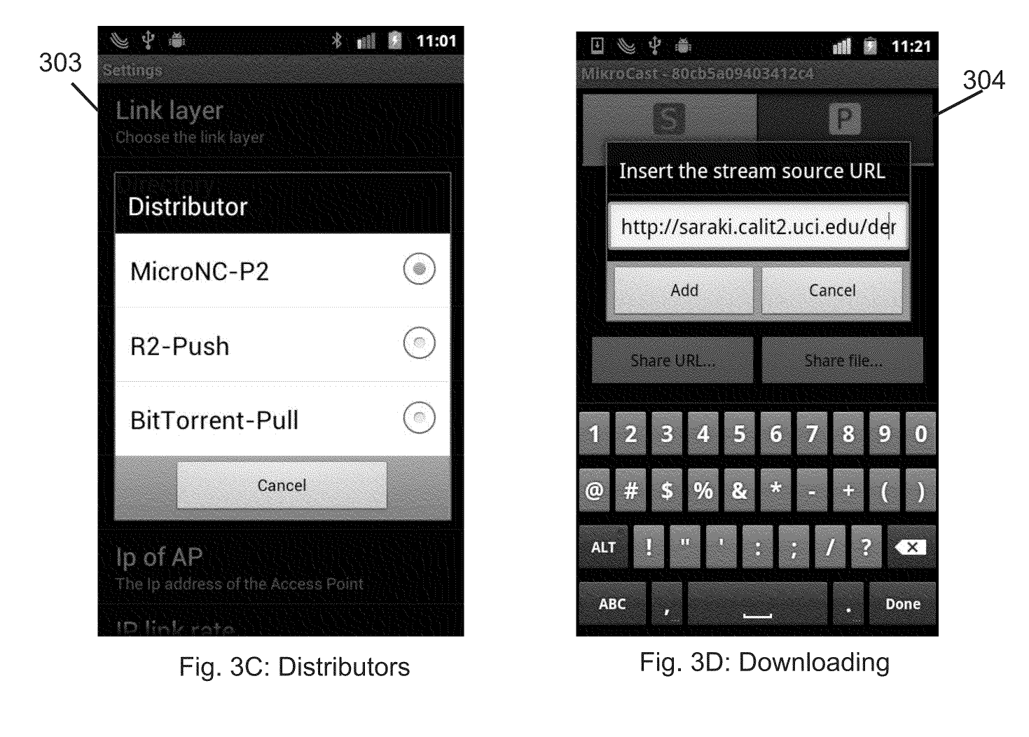

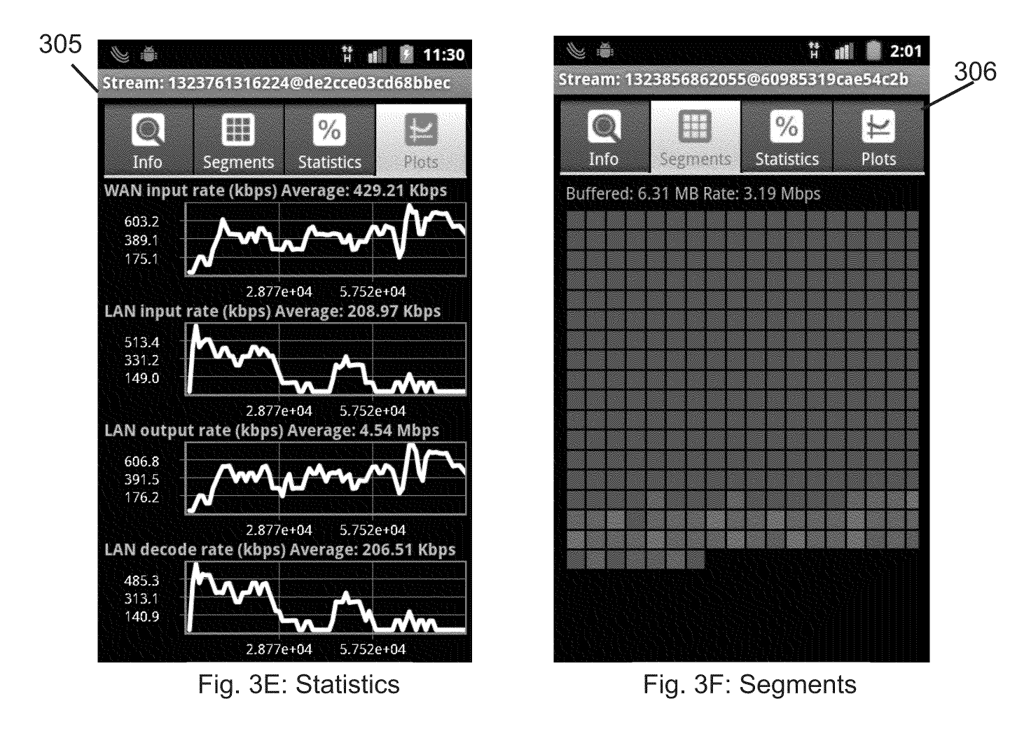

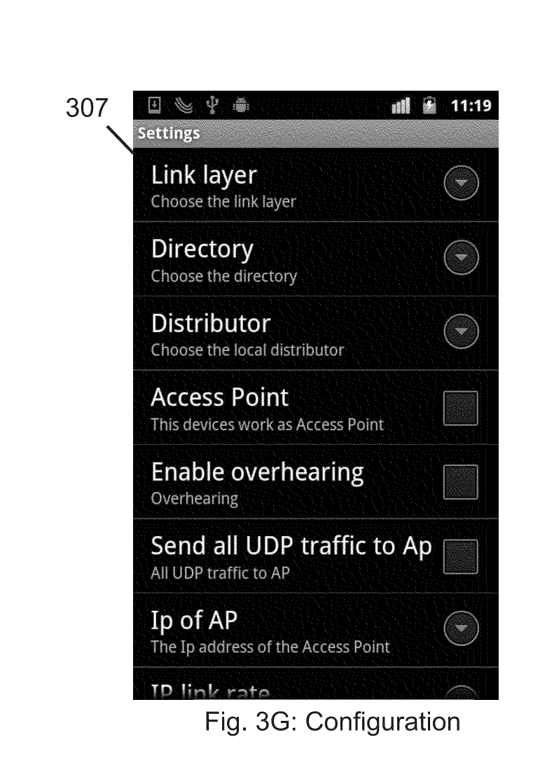

FIG. 3A illustrates a main options page of an exemplary graphical user interface for use with the present system, according to one embodiment.

FIG. 3B illustrates an information page of an exemplary graphical user interfaces for use with the present system, according to one embodiment.

FIG. 3C illustrates a distributors page of an exemplary graphical user interfaces for use with the present system, according to one embodiment.

FIG. 3D illustrates a downloading page of an exemplary graphical user interfaces for use with the present system, according to one embodiment.

FIG. 3E illustrates a statistics page of an exemplary graphical user interfaces for use with the present system, according to one embodiment.

FIG. 3F illustrates a segments page of an exemplary graphical user interfaces for use with the present system, according to one embodiment.

FIG. 3G illustrates a configuration page of an exemplary graphical user interfaces for use with the present system, according to one embodiment.

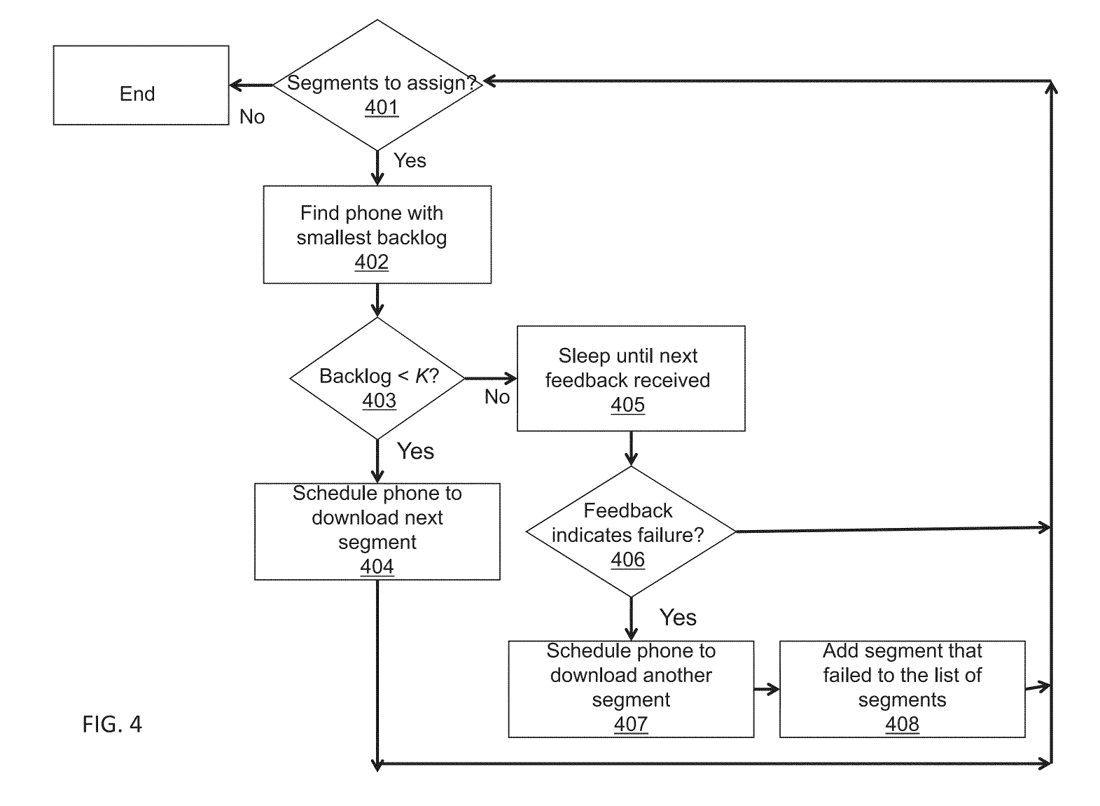

FIG. 4 illustrates an exemplary download algorithm for use with the present system, according to one embodiment.

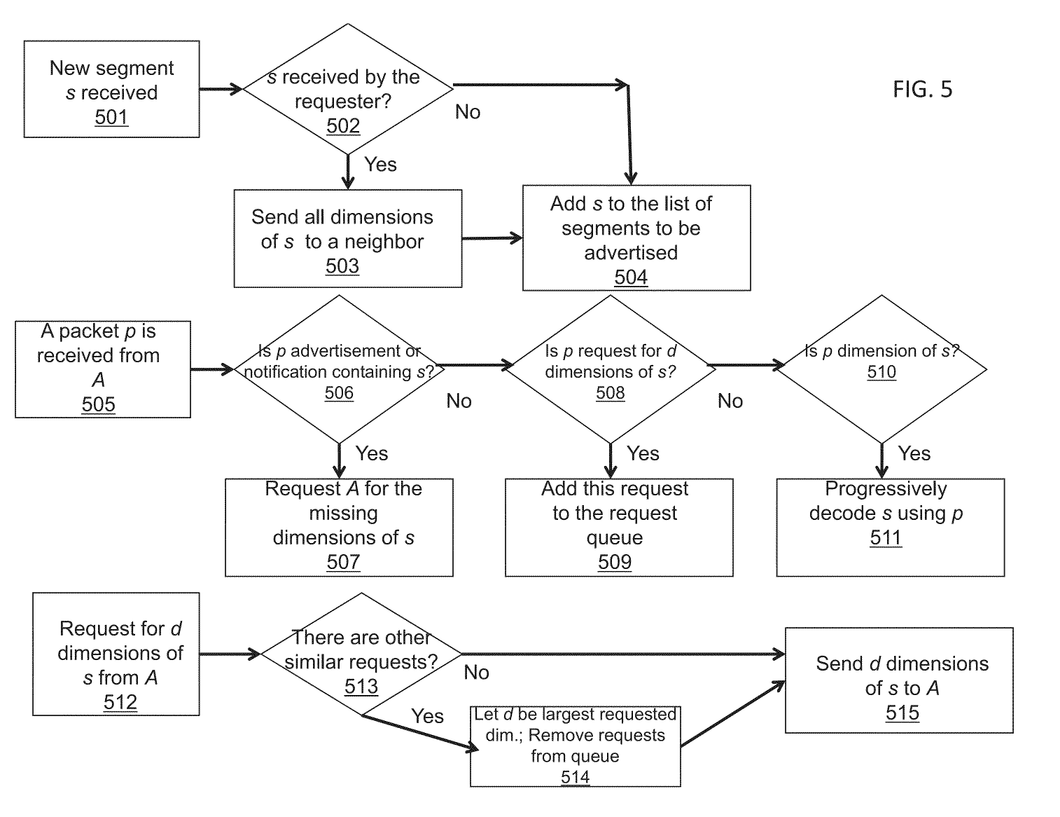

FIG. 5 illustrates an exemplary dissemination scheme for use with the present system, according to one embodiment.

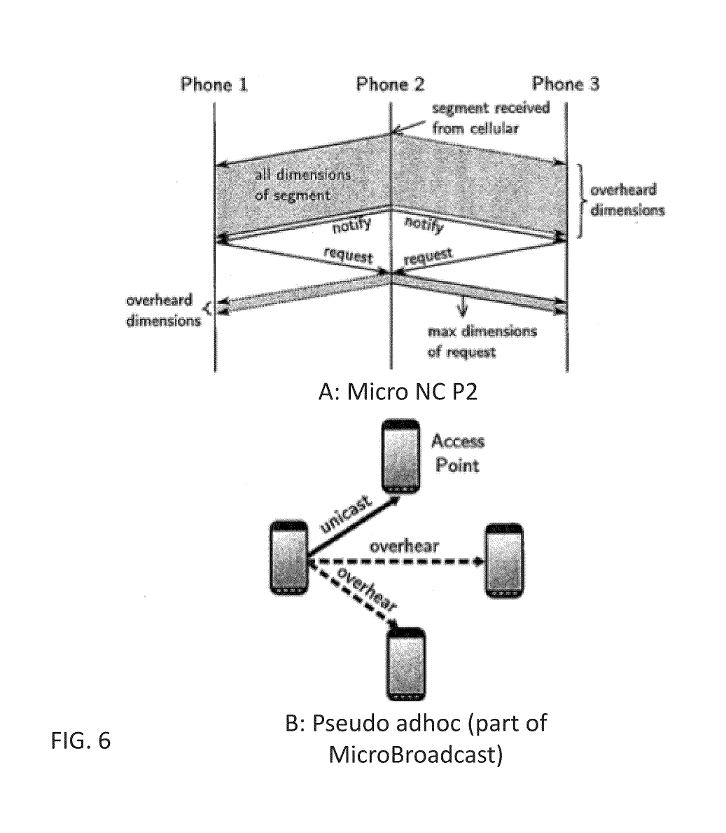

FIG. 6A illustrates a space-time diagram for an exemplary dissemination scheme for use with the present system, according to one embodiment.

FIG. 6B illustrates an exemplary pseudo ad hoc algorithm for use with the present system, according to one embodiment.

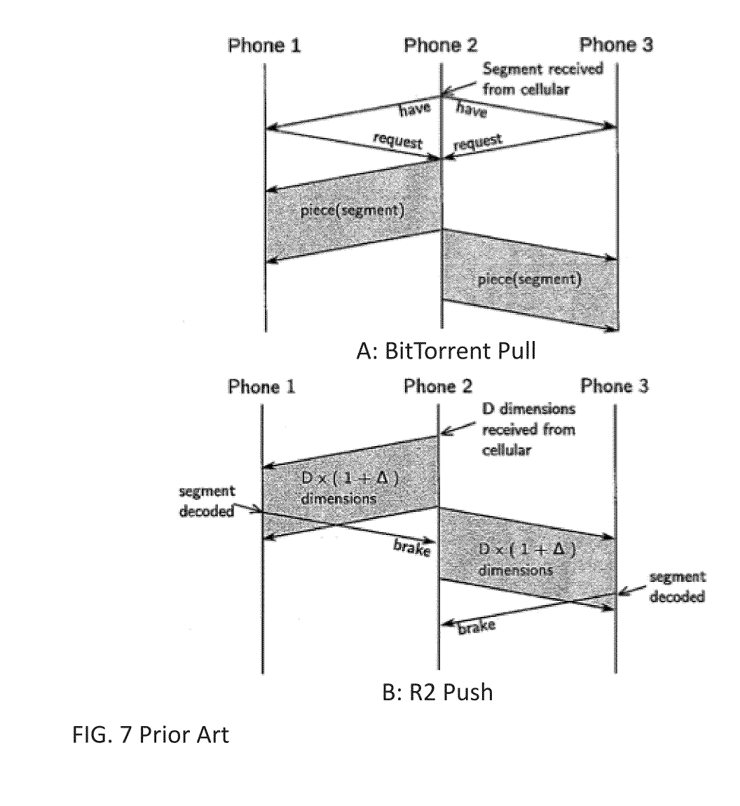

FIG. 7A illustrates a space-time diagram for Bit Torrent algorithm.

FIG. 7B illustrates a space-time diagram for R2 algorithm.

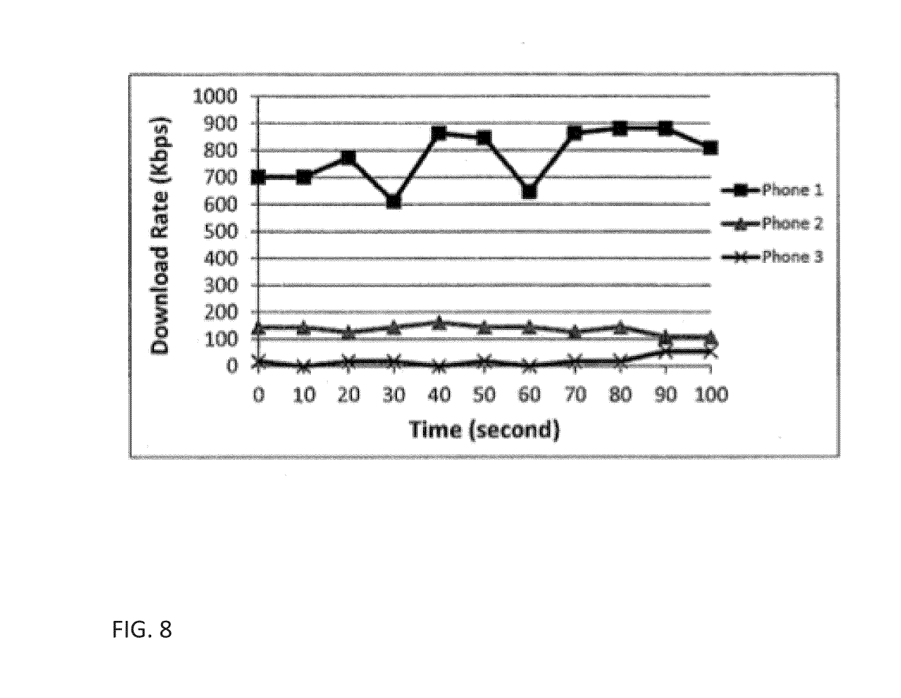

FIG. 8 illustrates exemplary cellular link rates of three mobile devices, according to one embodiment.

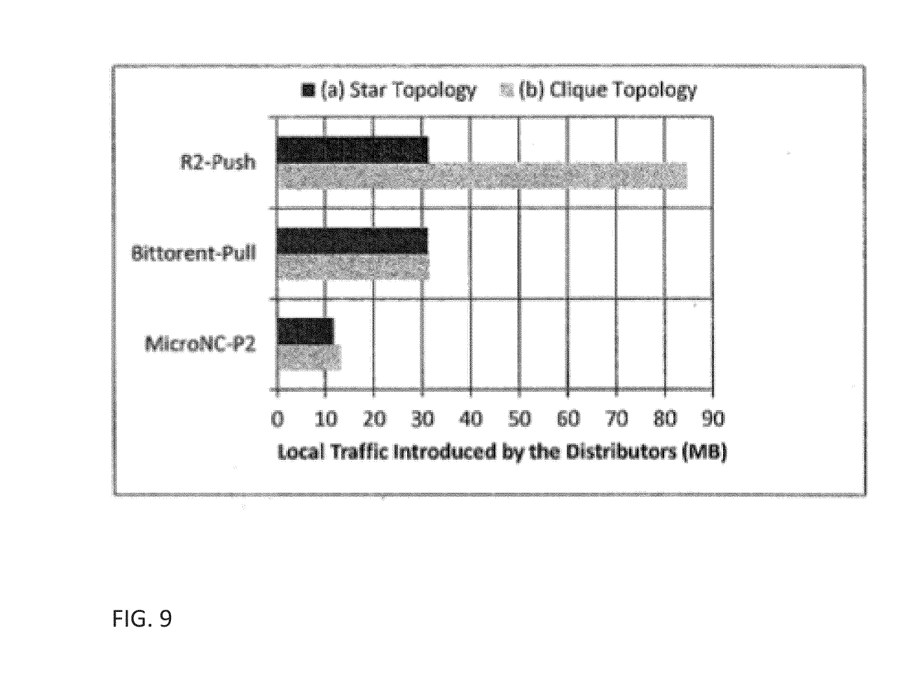

FIG. 9 illustrates exemplary local traffic comparisons, according to one embodiment.

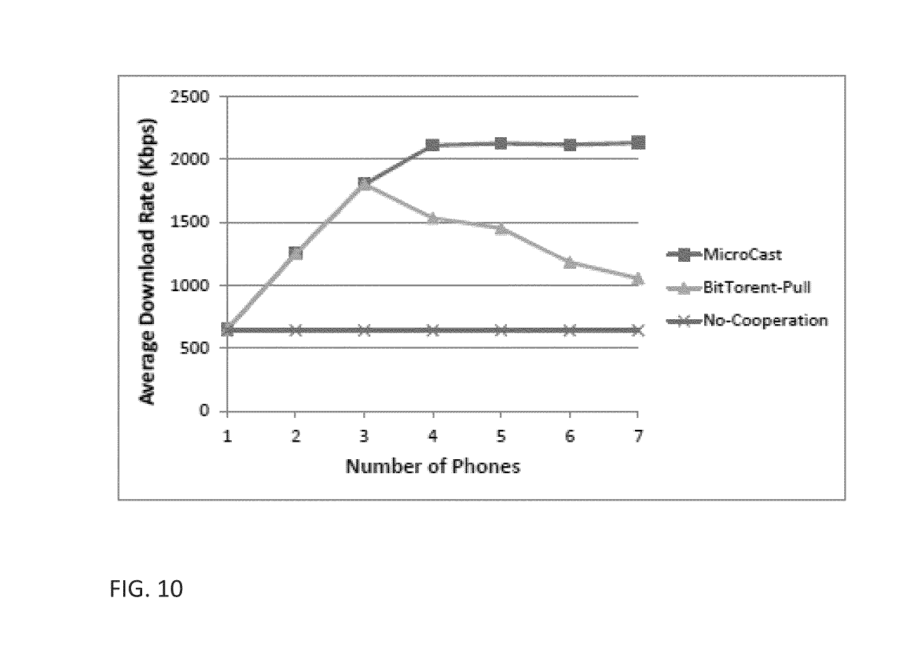

FIG. 10 illustrates exemplary download rate comparisons, according to one embodiment.

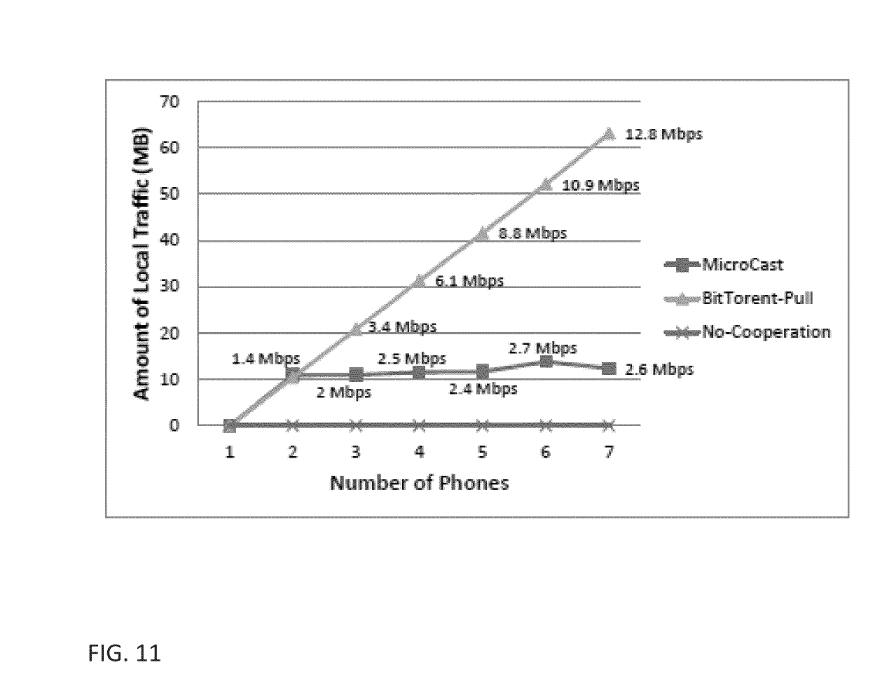

FIG. 11 illustrates exemplary traffic comparisons as a function of the number of devices, according to one embodiment.

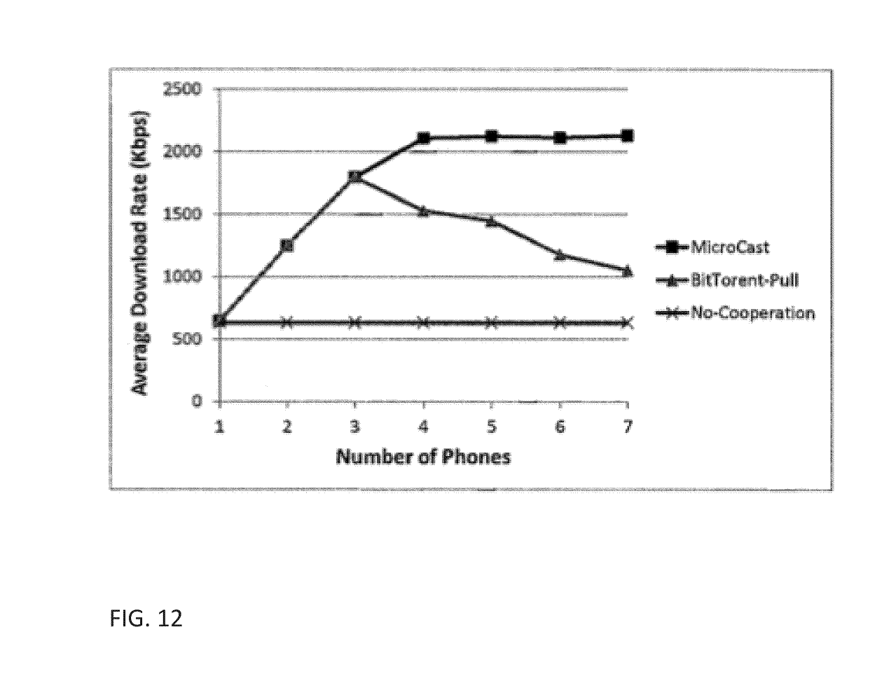

FIG. 12 illustrates exemplary download rate comparisons as a function of the number of devices, according to one embodiment.

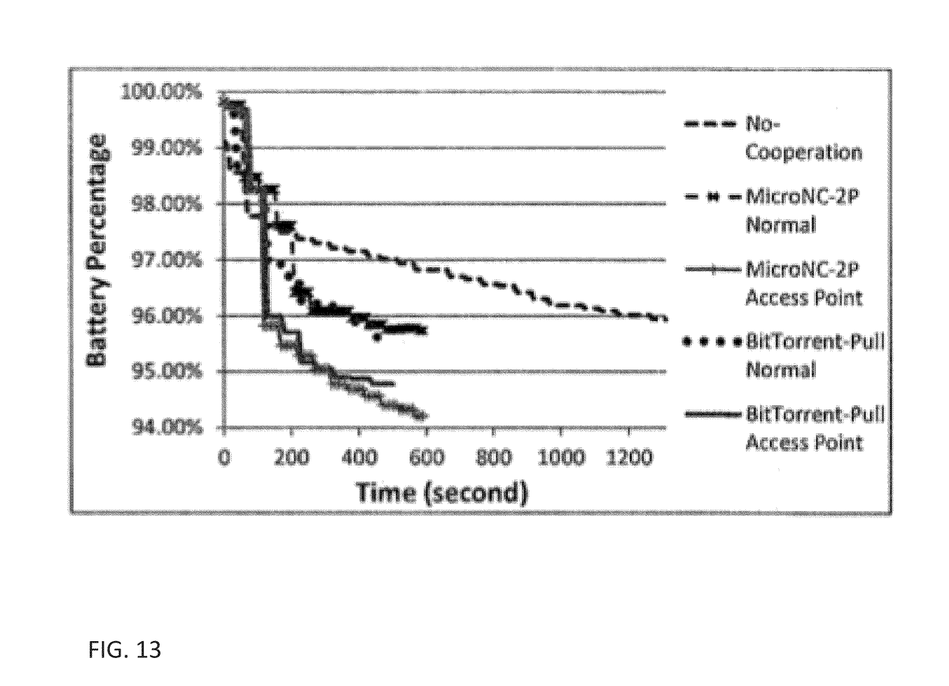

FIG. 13 illustrates exemplary battery consumption, according to one embodiment.

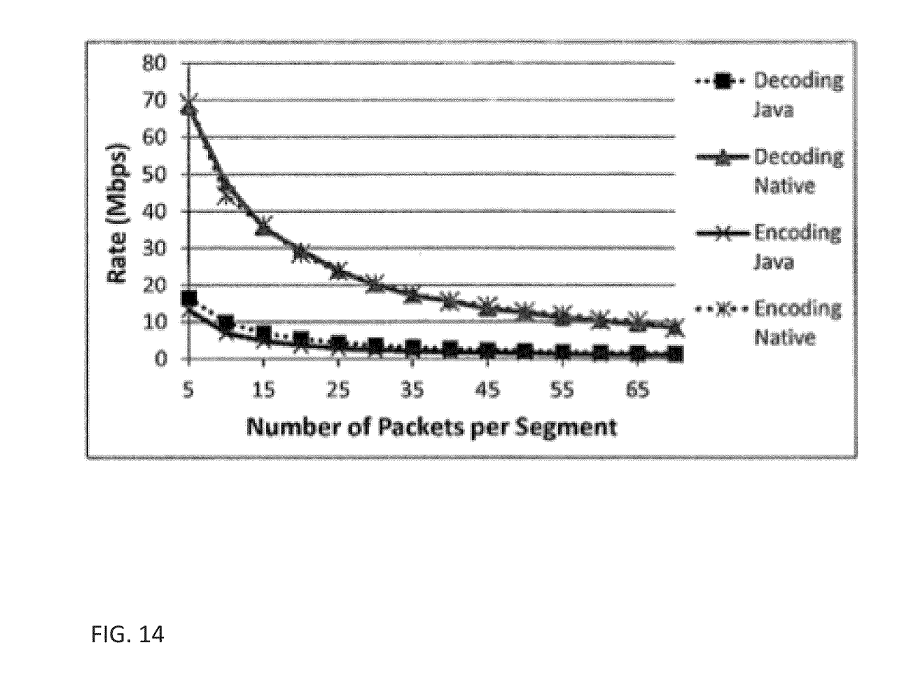

FIG. 14 illustrates exemplary decoding and encoding rates, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not necessarily describe every aspect of the teachings disclosed herein and do not limit the scope of the claims.

### DETAILED DESCRIPTION

A system and method for cooperative data streaming are disclosed. According to one embodiment, a system for cooperative data streaming comprises a group of devices, comprising at least two devices, which are all interested in obtaining the same content (e.g. video) from a server. Each device comprises one or more primary network interfaces connecting the device to the data streaming service and one or more secondary network interfaces connecting the device to one or more of the other devices through one or more wireless local networks. The primary network interfaces are configured for connecting the devices to the data streaming service for receiving at least segments of data in stream mode. The secondary network interfaces are configured for mutually connecting said devices in order to locally exchange said received segments of data.

Video streaming is one of the increasingly popular, as well as demanding, applications on mobile devices. The present system considers a group of mobile devices users, within proximity of each other, who are interested in watching the same video from the Internet at the same time. Watching the video on the same screen is not comfortable for more than two people; users may also prefer to watch the video on their own screens.

Prior art approaches include each user downloading the video independently using his or her own cellular connection, which often leads to poor quality as a result of insufficient cellular connections. Consider, for example, that a user wants to show her friends a YouTube video clip while being in a restaurant; a group of friends who want to watch a live soccer match together on their phones while at a remote location (e.g. camping or skiing); or a family who wants to watch a movie on their phones in the train or in the car; or a group of co-workers who want to watch a lecture using WiFi at a busy hotspot, such as the company cafeteria or a conference room. In all of these cases, some or all of the users may have poor or intermittent cellular connectivity, depending on the coverage of their providers, or may face congestion in the local network (e.g. when they want to use WiFi to download).

Fortunately, because the users engage in a group activity, this scenario naturally lends itself to cooperation. Furthermore, when every mobile device has multiple parallel connections (e.g. cellular, WiFi, and Bluetooth), there are even more available resources that, if properly used, can further improve the user experience.

A special case of the general scenario is when the video content is stored locally on one of the mobile devices and the user wants to share it with the other members of the local group. For example, a teacher wants to share a video with the students in a class; or a group of friends wants to share a video recorded of a group activity stored on one of the devices. In these cases, cooperation can also help.

The present system, according to one embodiment, is directed to a cooperative scheme for video streaming to a group of mobile devices within proximity of each other. Each mobile device utilizes simultaneously two network interfaces: one (e.g. cellular) to connect to the video server and download parts of the video; and the other (e.g. WiFi) to connect to the rest of the group and exchange downloaded parts. The present system optimizes the usage of cellular links to ensure that all the available bandwidth is used when channel conditions are good so as to compensate for potential long periods of bad channel conditions. The present system also optimizes the dissemination in the local area so as to ensure that even in the presence of heavy interference from other networks, the mobile devices can still collaborate.

According to one embodiment of the present system, each mobile device downloads the video much faster than it is played out when the conditions are good, in order to reduce the likelihood of buffering during the playback when the radio conditions significantly deteriorate.

The present system includes multiple algorithms; each of which is novel, outperforms baselines, and can be used standalone and in their combination into the overall system. The present architecture is modular, thus allowing for swapping various components (e.g., different wireless technologies, streaming protocols, scheduling and dissemination algorithms). The mechanisms used by each component are optimized so as to outperform alternatives and work in a synergetic way.

The present system comprises the following components:

(a) MicroDownload: This is a scheduler for cooperative downloading over all available downlink connections. The scheduler includes an algorithm for deciding which parts of the video each mobile device should download from the server and distribute on the local network, depending the device's potentially time-varying, download rate.

(b) MicroDistributor: This is an all-to-all local dissemination scheme for sharing content among group members using local connections, being either WiFi or Bluetooth. Different algorithms can be implemented to exploit the specific characteristics of the chosen connections. For instance, the algorithm presented herein for WiFi leverages the combination of network coding and WiFi overhearing (provided by the MicroBroadcast mechanism, described below) to efficiently share the downloaded parts of the video locally. This algorithm, referred to herein as MicroNC-P2, significantly outperforms state-of-the-art P2P schemes, including BitTorrent and the network coding-based R2 algorithm, which are not optimized for the particular setting (mobile devices within proximity of each other, connected through wireless links).

(c) MicroBroadcast: This module implements a comprehensive networking stack, which currently operates on wireless technologies including WiFi 802.11 and RFCOMM Bluetooth. MicroBroadcast provides an interface up to the MicroDistributor that exposes characteristics of the chosen local wireless connection. For instance, when WiFi is used in the local network, MicroBroadcast provides the ability to pseudo-broadcast over WiFi, e.g., the combination of unicast and overhearing, by exploiting the broadcast nature of the wireless medium. For Bluetooth, it provides multi-hop routing and message flooding on top of the usual reliable message exchange and peer discovery.

It will be appreciated that while the algorithms described herein are referred to using particular names, the present disclosure relates to algorithms implementing similar functionality despite naming conventions. The present system can be applied to any device, including without limitation, a computer, laptop, sensor, mobile phone, a tablet, a music player device, a GPS mobile navigation device, a camera, a video camera, or a personal digital assistant (PDA). The present system can be applied not only to video data, but also to other types of data, including for example image data and audio data.

The expression “in proximity” related to the devices indicates that the distance between devices is such that the devices can directly communicate by exploiting the wireless medium, e.g. using a Bluetooth or a WiFi interface. For example this distance depends on the broadcast limitations of the technology.

Although the described architecture and experimental results are related to Android-based devices, the present system can be applied to devices using other operating systems as for example Symbian, Apple iOS, RIM Blackberry, MeeGo, Windows Phone, Boot2Gecko (B2G) and Bada.

The present system comprises a group of devices, each device comprising a set of wireless interfaces, for example two wireless interfaces (cellular interface, Bluetooth interface, and WiFi interface) used at the same time. The set of wireless interfaces comprises:
One or more primary network interface, through which the downloading from a data server happens, for example a WiFi or cellular interface. The server can be one of the group devices;
One or more secondary network interfaces, through which one or more of the devices connect directly to each other wirelessly (e.g. WiFi and Bluetooth, as well as wireless protocols for military applications).

According to one embodiment, MicroDownload, is implemented in a first electronic module, MicroDistributor in a second electronic module, MicroBroadcast in a third electronic module, a requester in a fourth electronic module and storage in a fifth electronic module.

According to one embodiment, the present system enables cooperative video streaming without modifying the operating system of the devices. The present system is also implemented as an application that is possible to download and install on a device.

According to one embodiment of the present system, scheduling of which device should download which segment is based on the downloading rate (and the backlog) of the devices. In another embodiment it is based also on the connectivity rates on the secondary networks. For example, if it is not possible to send a segment through a secondary network, the segment is rescheduled to be downloaded again on some of the devices through a primary network.

The present system aims to allow each mobile device to receive at a rate equal to the sum of the cellular download rates of all mobile devices in the cooperative group. (If the local network is congested, this may limit the potential increase in the rate.) The increased rate may be higher than the playback rate of the video; this is useful to reduce the probability of a buffer underflow during playback. Downloading at a rate higher than the playback rate requires caching of the stream locally.

FIG. 1 illustrates an exemplary system level scenario for use with the present system, according to one embodiment. A group of mobile device users 108 having mobile devices 104, 105, 106 are within proximity of each other and are interested in downloading and watching the same video at the same time. Each mobile device 104, 105, 106 simultaneously uses two interfaces: the cellular interface 103 to connect to the server 101, and the local interface (WiFi) 107 to connect to all other users in the group 108. Each mobile device 104, 105, 106 downloads segments of the video 102 from the server 101 and shares these with the rest of the group 108 locally. In every mobile device, the cellular connection 103 is used for the downlink, and WiFi 107 to establish local, device-to-device links. This allows for use of the two connections (cellular and WiFi, for example) on each phone simultaneously and independently. Note that cellular and WiFi connections are used in parallel, but one connects directly to the server (cellular), while the other connects to the other users (WiFi); both of these connections are not used to connect a user directly to the server through two different paths. Note also that the downlink and local link are independent of each other. In the preferred embodiment, cellular is used for the downlink and WiFi is used for the local link. According to another embodiment, cellular is used for the downlink and Bluetooth is used for the local link. In yet another embodiment, WiFi is used for the downlink while Bluetooth is used for the local link.

FIG. 2 illustrates an exemplary architecture for use with the present system, according to one embodiment. According to one embodiment, an exemplary download capability (distributed MicroDownload) 204 runs only on one of the phones (in a group) that initiates the download. It instructs the requesters 203 of all phones which segments to download from the server. In another, distributed version of Microdownload, this capability lies in each device and instructs the Requester of that particular device which segments to download from the server.

An exemplary dissemination scheme (MicroDistributor) 205 is responsible for distributing segments using the local wireless network. MicroDistributor 205 specifically exploits an exemplary broadcast capability (MicroBroadcast) 206 provided by its lower layer to distribute segments quickly and efficiently. MicroBroadcast 206 implements a comprehensive networking stack, which operates on wireless technologies including WiFi 802.11 and RFCOMM Bluetooth. MicroBroadcast 206 provides the ability to pseudo-broadcast over WiFi 208. MicroBroadcast 206 also supports unicast, reliable and unreliable message exchange between the network participants over both WiFi and Bluetooth. It also includes multi-hop routing, network-wide flooding, and peer discovery.

In order to facilitate porting of the application to different wireless technologies, MicroBroadcast contains an application layer implementation of a networking stack. Depending on the wireless technology used, features of MicroBroadcast are either implemented using a native mechanism or emulated. For example, a Bluetooth-based implementation can re-use the native peer discovery mechanism, while a WiFi-based implementation can run a custom peer discovery protocol.

Requester 203 retrieves segments of the video from the video source. A Requester module 203 runs on all mobile devices of the group. Depending on the video source location, one or more of the mobile devices might be able to request segments. For example, if the video is locally available on one of the mobile devices, only the mobile device having the file requests segments (from its local memory where the file is stored). If the video is on a remote HTTP server, only the phones with cellular connections request segments. The requester 203 internally uses components called producers to retrieve segments of the video from the source of the stream. According to one embodiment, the requester 203 contains producers for three types of sources: HTTP, file, and content. The first (HTTP) loads segments from an HTTP server using range requests. The second (file) loads video from locally available files. Finally, the third (content) retrieves data using, for example, the ContentProvider API of Android (e.g., videos can be captured with the device camera). The HTTP producer is agnostic to the actual networking technology used to access the server. Therefore, it can work not only when the phones use a cellular 207 network to access the video server, but also when using an infrastructure mode WiFi network. The overhead of using range requests measured in bytes is relatively small, around 3% when using segments of 22500 bytes, as an example. The download of segments is affected by round-trip time, but if the HTTP server hosting the video supports persistent connections, all requests can be carried out in a single TCP connection, thus saving some overhead. To further reduce the impact of round-trip time, the usage of multiple parallel TCP connections is supported in the present system on each phone.

Storage 202 is used to cache the received segments for successive playback. The segments are stored in the internal flash memory of the mobile device to keep the application memory requirements low. It is possible to access the segments from the storage either using a Java API, or via an embedded HTTP server. This second interface allows for playing the video stream using the native media API. In order to support playback of non-streamable video (e.g., MP4 files with moov atom at the end of the file) the embedded HTTP server supports range requests. If a range that has not yet been downloaded is requested, the HTTP server waits until it receives the full range before answering.

Graphical User Interface (GUI) 201 provides an interface to users to create video streams, share local videos, start/stop downloading video files, join existing video streams, and play/pause video. In addition to these basic features, the GUI lets users discover and connect to other devices, specify the wireless interface that should be used for the local dissemination, and decide whether the phone should collaborate for video downloading. The GUI also allows users to select system modules as well as run-time parameters for experimental purposes. The GUI provides live feedback during the experiments, and provides detailed statistics after the experiments. These functionalities of the GUI facilitate field tests.

The GUI automatically displays the locally reachable peers to form a group, and which streams (if any) are being downloaded in the group. The user only needs to select the desired stream and join it. The mobile devices can play the video in a synchronized manner or at their own pace. Playback and download are decoupled thanks to the storage mechanism: a mobile device can be participating in the download while its video player is paused. To render the video, use is made of a media playback API which supports various containers and video formats, such as H.264 in a MP4 container. The video can be displayed while still downloading; therefore, live streaming is supported.

FIGS. 3A-3E illustrates exemplary graphical user interfaces for use with the present system, according to one embodiment. FIG. 3A illustrates an exemplary main options interface 301. FIG. 3B illustrates an exemplary information interface 302. FIG. 3C illustrates an exemplary distributors interface 303. FIG. 3D illustrates an exemplary downloading interface 304. FIG. 3E illustrates an exemplary statistics interface 305. FIG. 3F illustrates an exemplary segments interface 306. FIG. 3G illustrates an exemplary main configuration interface 307.

FIG. 4 illustrates an exemplary download algorithm for use with the present system, according to one embodiment: a centralized implementation of MicroDownload. According to one embodiment, the desired video for download is divided into segments of fixed size. The exemplary download algorithm, referred to herein as MicroDownload, handles the scheduling of which mobile device should download which segment. If there are segments to assign 401, the mobile device having the smallest backlog 402 (i.e., the set of segments a mobile device has to download from its cellular connection) is assigned the next segment for download 404 provided the backlog of the mobile device is smaller than a fixed number (K) 403. Initially, each mobile device is assigned a fixed number (K) of segments. The mobile devices try to download one after the other the segments that are assigned to them. If a mobile device downloads a segment successfully, it provides feedback as a notification 405. Otherwise, it reports failure 406. The failed segments are reassigned (based on the backlogs) 407, 408. This mechanism ensures that no segment remains trapped in mobile devices that have bad cellular connectivity. Also, this mechanism adapts segment download to the varying rates and conditions of cellular links. For example, if a mobile device has a bad cellular connection, its assigned requests are rescheduled and reassigned to other mobile devices (which hopefully have better connections). However, some segments are still assigned to the mobile device with the bad cellular connection so that it can start downloading immediately as soon as its channel quality improves.

An alternative implementation is Distributed MicroDownload—a distributed way for mobile devices to coordinate to download different parts of the same video. A video is partitioned into blocks. Before downloading blocks, a mobile device A reserves a batch of them by announcing to the other mobile devices in the same local network that it intends to download these blocks in the batch. Upon receiving this announcement, the other mobile devices do not download these blocks to avoid redundant download. After finishing downloading the blocks in the reserved batch, the mobile device A may push these blocks to the other mobile devices or just announce that it has downloaded these blocks so that the other mobile devices, when needed for playback, could pull from it these blocks using the local network instead of the cellular network. If the attempt of, say mobile device B, to download blocks from the local peers, say mobile device A, fail because (i) A left, or (ii) the blocks was not downloaded on time due to congestion of the cellular link of A, (iii) or the local network is congested, then phone B will download these blocks himself using his own cellular link. This way, each mobile device can cooperate to speed up the download or can independently download blocks (in case of congestion on either the local or other devices' cellular connection).

Distributed MicroDownload makes sure that the rate at which a mobile device downloads is always the mincut of the connectivity graph involving the mobile devices, the video server, the local links, and the cellular link. This is true even in the case of congestion in the local network, which Centralized MicroDownload couldn't achieve. Centralized MicroDownload also fails to operate when the local network is congested because it relies on the arrival of control packets that indicate what blocks each device should download. With Distributed MicroDownload each mobile device could operate independently, even in the case the local link is heavily congested.

FIGS. 5 and 6A illustrate an exemplary dissemination scheme, for use with the present system, according to one embodiment. According to one embodiment, each segment downloaded by a mobile device is divided into packets and distributed to the remaining phones using the local network. To do so, the present system utilizes a custom dissemination scheme that exploits the benefits of overhearing and network coding. At a high level, the scheme takes advantage of pseudo-broadcast, i.e., unicast and overhearing, to reduce the number of transmissions. Furthermore, instead of disseminating regular packets, the present scheme disseminates random linear combinations of packets of the same segment, i.e., dimensions of subspaces or network coded packets. This is to maximize the usefulness of overheard packets. The local dissemination scheme is referred to herein as MicroDistributor, while the specific implementation shown in FIGS. 5 and 6A is referred to herein as MicroNC-P2, where P2 refers to an initial Push and subsequent Pulls).

In the present dissemination scheme, MicroNC-P2, a mobile device, B, periodically advertises the segments that it currently has to its neighbors 505, 506. Then, a neighbor, mobile device A, requests segments that it does not have based on the advertisement 507. Upon receiving the request, mobile device B sends the requested segments to mobile device A. More specifically, when mobile device A requests a segment s from mobile device B, it takes into account previously overheard dimensions of the sub-space representing segment s. In particular, it explicitly indicates in the request how many additional dimensions it needs to receive to decode s. This reduces the number of dimensions to be sent. (507-511)

When mobile device B is about to serve a segment s requested by mobile device A 512, it first checks if there are pending requests for the same segments from other neighbors 513. If there are, it finds the maximum number of dimensions requested among these requests 514. Denote this maximum dimension by d. If there is none, d is the number of dimensions requested by A. Afterwards, B serves d dimensions of segment s to A 515. The other mobile devices, which need up to d dimensions of s, should be able to get the dimensions through overhearing.

After serving A, B notifies all mobile devices that requested some dimensions of segment s. Upon receiving the notification, these mobile devices check if they received all the necessary dimensions to decode s. If not, they send requests for additional dimensions. This is necessary, because overhearing is not guaranteed for all dimensions sent by B and for all mobile devices. Finally, the scheme gives higher priority to requests that are closer to the playback time when serving them. Overhearing and unicasts effectively allow for pseudo-broadcast. As described, the amount of traffic saved by pseudo-broadcasting segment s depends not only on the quality of the overhearing but also on the number of requests of segments s from other phones that A processes at the time of broadcasting.

To be concrete, consider a local network consisting of four mobile devices: A, B, C, and D. After finishing downloading segment s using cellular, A advertises it to B, C, and D. B, C, and D then send requests for this segment to A. For simplicity, assume perfect overhearing. First, consider the case where all requests arrive at A at a similar time. In this case, when A serves, e.g., B's request for segment s, A removes C and D's requests for s. Effectively, A serves all B, C, and D using a single transmission of s. Now, consider the case where the request from D arrives later than the time A initially serves s to B and C. The late arrival of D's request could be due to various reasons, such as large receiving and sending queues of D. A now has to serve D all dimensions of s even though D may overheard some dimensions initially sent by A to B (or C). Apparently, A needs to send more than needed.

To address this issue, an initial push of segment s occurs 501. Specifically, when A finishes downloading segment s 502, it sends all dimensions of s 503 to a randomly selected neighbor before advertising the segment 504. By doing so, A ensures that the initial dissemination of segment s is taken into account in subsequent requests for segment s (if any) of A's neighbors. This effectively creates a perfect synchronization of the reception of the initial requests of segment s.

In order to address loss of request and notification packets, which could lead to missing segments, the dissemination scheme includes a recovery thread. This thread periodically re-requests segments that were requested after a certain amount of time but never received.

As described above, MicroNC-P2 involves coded transmissions. Generation-based network coding can be used over the field GF(2⁸), for example. Each segment is broken down into m packets bᵢ, which together form one generation (or segment), where m is the segment or generation size. Each packet contains n bytes, and each byte is a symbol in GF(2⁸). Each packet is augmented with the m coding coefficients, each of which is selected uniformly at random from GF(2⁸). Thus, each packet can be seen as a vector of length n+m symbols from GF(2⁸). Device A sends to device B linear combinations of packets of the same segment, where the coding coefficients used to create linear combinations are selected uniformly at random from GF(2⁸).

Device B can decode a segment upon receiving m linearly independent combinations of packets of the segment. Let M denote the matrix formed by m linearly independent packets: M=[E|C], where E is of size m×n and C is the coefficient matrix of size m×m. Original packets bᵢ can be recovered by finding the inverse of C. In particular, C⁻¹. [E|C]=[B|I], where B is the matrix of size m×n whose row is bᵢ and I is the m×m identity matrix. Inverting C takes Θ(m³) and multiplying C⁻¹ with [E|C] takes Θ(m²(n+m)) in terms of finite field multiplication. Thus, the decoding takes Θ(m³+nm²) in total. Generating m randomly encoded packets can be done by generating a random coefficient matrix R of size m×m and multiplying R with [B|I]. Thus, the encoding of a segment also takes Θ(m³+nm²) in total.

Network coding is a CPU intensive operation. In the present system, encoding and decoding must be performed efficiently, at a rate matching that of the local network dissemination; otherwise, CPU risks may become the bottleneck of the video distribution.

According to one embodiment, reducing CPU usage is implemented by limiting the size of the coding generation. The smaller the number of packets in each segment, the smaller the coding complexity. Using smaller segment sizes, however, reduces the diversity of encoded packets, i.e., packets are less likely to bring innovative information to their recipients.

According to one embodiment, reducing CPU usage is implemented by optimizing network cording. In particular, pure Java and native code approaches are used. In the first implementation, the encoding and decoding operations are performed by code that runs in the Dalvik virtual machine. In the second approach, the code runs natively on the phone CPU and is invoked through the Java Native Interface. The Java implementation has the advantage of being portable across different hardware platforms but is less efficient than the native version. In both implementations, table lookups are used to perform finite field multiplication and division, and the bit-by-bit XOR operation is used to perform addition and subtraction.

For small packet lengths, for example, equal to 900 (bytes), segment length equal 22, 500 (bytes), and (resulting) generation size equal 25, inverting the coefficient matrix C takes roughly 8% of the decoding time (measured on the native implementation). The rest of the time is used to recover the original vector by linearly combining the received packets (multiplying C⁻¹ with [E|C]). The Java implementation can encode at 2.9 Mbps and decode at 4.3 Mbps (the significant difference in rate is due to a different memory usage pattern), while the native implementation can both encode and decode at 24 Mbps. The Java implementation is sufficient for low bit-rate videos while the native implementation can support even high-quality video streaming (indeed, with the native implementation, experiments show that the present system can support 2.5 Mbps stream to a group of 7 mobile devices). The numbers presented herein are examples, and streaming will improve as mobile device technology improves.

FIG. 6A illustrates a space-time diagram for the MicroNC-P2 dissemination scheme for use with the present system, according to one embodiment. The dissemination scheme as described with reference to FIG. 5 is depicted in a space-time diagram.

Although mobile devices within proximity of each other can, in principle, overhear all transmissions, high-rate broadcast is not possible with the existing modes. The unicast mode of 802.11 does not exploit broadcast: it (redundantly) transmits the same packets to each receiver separately. The broadcast mode of 802.11 has its own disadvantages: (i) it lacks a back-off mechanism, which may harm the performance of other flows; (ii) its transmission rate is limited to the minimum (base rate, 1 Mbps); (iii) finally, unlike laptops, it is not always possible to adapt the broadcast transmission rate on Android mobile devices due to wireless driver and firmware limitations.

A possible solution is to use pseudo-broadcast, i.e., overhearing, which combines the benefits of unicast and broadcast. Unicast is used as the transmission mode, but the mobile devices overhear all transmissions in their neighborhood. Therefore, pseudo-broadcast combines the desirable properties of unicast (high rate, back-off) with overhearing, which makes it attractive.

FIG. 6B illustrates an exemplary pseudo ad hoc algorithm for use with the present system, according to one embodiment.

Another challenge is that overhearing is possible only in infrastructure mode. In infrastructure mode, all transmissions are relayed through the access point (AP), thus resulting to double the amount of traffic in the WiFi local network. To solve this problem, the present system includes a pseudo-ad-hoc mode, depicted in FIG. 6B. WiFi is used in infrastructure mode: one device is selected and acts as access point (AP) and every transmitting device sends a unicast to the AP. However, the AP does not forward the transmission further. This way, pseudo-adhoc ensures only one transmission per packet (which is the case in ad-hoc mode), thus the term pseudo-adhoc mode.

The broadcast algorithm, MicroBroadcast, provides to the dissemination scheme, MicroDistributor, an interface for high-rate local broadcast. The preferred implementation of MicroBroadcast is on WiFi and combines the following: (i) putting the devices on promiscuous mode so they can overhear all other packets (ii) filtering overheard packets before passing them up to the application layer and (iii) pseudo-ad-hoc as described above.

FIG. 7A illustrates a prior art space-time diagram for a Bit Torrent pull operation. Fundamentally, Bit Torrent is a pull-based P2P protocol: when a mobile device has downloaded a new segment, it advertises this segment to its neighbors. The neighbors then explicitly request the segments that they are missing.

FIG. 7B illustrates a prior art space-time diagram for an R2 push operation. In contrast to Bit Torrent-Pull, with R2-Push, the mobile devices start pushing linear combinations of segments as soon as they receive them from either the cellular network or their neighbors. FIGS. 7A and 7B are provided as state-of-the-art alternatives for comparison.

### Discussion of Exemplary Experimental Results

FIG. 8 illustrates exemplary cellular link rates of three smartphones. The setup is the following: three Nexus S devices were connected to the same cellular network provider, and then placed within proximity of each other (the distances among them were approximately 2 cm) in an indoor environment. The phones were placed in their positions 5 minutes before the experiment started to eliminate any possible positive or negative bias due to mobility.

The download rates of the smartphones over 100 seconds without enabling the present system. The results are presented in FIG. 8. Despite being in close proximity and being connected to the same operator the phones experience significantly different average download rates. Phone 3 has a very low rate because it uses EDGE. The other two phones use the same cellular network but still have significantly different download rates. Moreover, phone 1 experiences significant rate variations.

Using these measurements, the effectiveness of the present download algorithm can be compared to a simpler static strategy. Consider a scenario where the three phones download a 750 kB file, and the present download algorithm makes a static decision, i.e., each phone requests one third of the file. In this case, phone 3 (considering the same channel realization as in FIG. 8) is the bottleneck for downloading the file, and the total download duration is 80 seconds. However, if the present download algorithm is enabled and makes adaptive requests, then phone 3 is not a bottleneck anymore, and the total download duration is less than 10 seconds. This shows the importance of the adaptive request mechanism of the present download algorithm.

FIG. 9 illustrates exemplary local traffic comparisons, according to one embodiment. FIG. 9 illustrates the amount of local traffic introduced by the phones when using different distributors. The file being downloaded in this example is 9.93 MB. Bandwidth of the local network is sufficient to support the local dissemination. All phones receive the file at a similar rate 550 Kbps. MicroNC-P2, or the present dissemination scheme, manages to introduce the least amount of traffic thanks to network coding and overhearing.

FIG. 9 illustrates that the amount of traffic introduced by both Bit Torrent-Pull and R2-Push are more than three times higher than that of MicroNC-P2. Intuitively, this is due to the fact that when using MicroNC-P2, a packet sent by a phone may be beneficial to three phones instead of one thanks to network coding and overhearing.

FIG. 9 also shows that in a clique topology, R2-Push introduces much more traffic as compared to the star topology, while Bit Torrent-Pull and MicroNC-P2 introduce similar amount of traffic in both clique and star topologies. This is due to the fact that in a clique topology, a phone may simultaneously receive linear combinations of the same segment from multiple neighbors. When this happens, it is critical that the neighbors who are sending to this phone stop pushing linear combinations in a timely manner. This could only be achieved with a timely arrival of the brake (stop) messages, which is not always possible in the clique topology, or in a setup where additional traffic is very high.

FIG. 10 illustrates exemplary download rate comparisons, according to one embodiment. The average download rate as a function of number of phones when the local network bandwidth is 20 Mbps. The performance of MicroCast (the present system) and Bit Torrent-Pull almost coincide on the plots. The average download rates of MicroCast are compared to two other schemes: no cooperation, which will be referred to as No-Cooperation, and the combination of MicroDownload and Bit Torrent-Pull, which will be referred to as Bit Torrent-Pull.

Up to seven phones were used in this experimental setup, the first four of which had 3G cellular rates varying from 480 Kbps to 670 Kbps. The rest of the phones did not have 3G cellular connections. Packets are exchanged locally using UDP. The local network can support up to 20 Mbps UDP traffic. Star topology and pseudo-ad hoc were used. The size of the video file is 9.93 MB. Each value reported in this section is averaged over three experiments.

FIG. 10 shows the average download rate versus the number of phones. FIG. 11 illustrates exemplary traffic comparisons as a function of the number of phones, according to one embodiment. Both MicroCast and Bit Torrent-Pull are able to improve the average download rate up to the sum capacity of the 3G cellular links. Note that MicroCast and Bit Torrent-Pull do not provide any improvement for more than four phones because only four phones have 3G cellular connections in this setup, and the average download rate is limited by the sum capacity of the four corresponding 3G cellular links. FIG. 11 shows the amount of local traffic versus the number of phones. Although in FIG. 10 there are similar average download rates for both MicroCast and Bit Torrent-Pull, FIG. 11 shows that Bit Torrent-Pull introduces a larger amount of local traffic (which increases linearly in the number of phones) as compared to MicroCast. This behavior of Bit Torrent-Pull is detrimental in terms of the average download rate in congested networks. An important observation is that, as the number of phones increases, MicroCast rate does not increase. This indicates that, even with many nodes, overheard packets are lost very rarely.

To evaluate the performance of MicroCast and Bit Torrent-Pull in a congested network, the congested network is generated by introducing 16 Mbps background UDP traffic on the same 802.11 channel (note that there is also interference from other sources in the environment which contributes to the background traffic). Since the local network can support up to 20 Mbps traffic, the leftover traffic is less than 4 Mbps.

FIG. 12 presents the average download rate versus the number of phones in this setup. The average download rate of Bit Torrent-Pull reduces when the number of phones is more than 3. This is because Bit Torrent-Pull introduces a large amount of local traffic (as illustrated in FIG. 11), which leads to congestion.

Note that the addition of the 5th, 6th, and 7th phones also increases the local traffic in Bit Torrent-Pull, even though they do not have cellular connections. This is because they still need to receive the file in the local area, which contributes to local area traffic.

FIG. 12 illustrates exemplary download rate comparisons as a function of the number of phones, according to one embodiment. FIG. 12 shows that MicroCast still improves the average download rate up to the total capacity of cellular links (of four phones) in a congested network. This is because it introduces only a small amount of local traffic (e.g., even for seven phones, MicroCast only introduces 2.6 Mbps traffic to the local net-work). It can be observed from FIG. 12 that the average download rate of MicroCast is more than three times higher than that of No-Cooperation. Also, the improvement of MicroCast over Bit Torrent-Pull in terms of average download rate is as high as 75%, which is significant.

FIG. 13 illustrates exemplary battery consumption, according to one embodiment. FIG. 13 presents the battery state (100% corresponds to the fully charged battery) versus time. These considerations show that the rate benefit of MicroCast comes at no significant battery cost.

FIG. 14 illustrates exemplary decoding and encoding rates, according to one embodiment. The performances of the two implementations of network coding are compared: native (written in C) and Java-based coding. FIG. 14 shows the highest achievable decoding and encoding data rates. The slowest encoding rate for the Java implementation is 1 Mbps, while for the native implementation, it is 8 Mbps, which is significantly higher than what is needed for video streaming applications. FIG. 14 also shows that the Java implementation is more than sufficient to stream today's typical Internet videos when using generation size equal 25.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

A system and method for cooperative data streaming have been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

What is claimed is:

1. A method for cooperative data streaming, comprising:
connecting a group of devices, the group comprising at least two devices, to a data streaming service comprising at least one data streaming server in such a way that each device receives from the data streaming service segments of data over at least one primary network interface;
connecting the devices in the group in order to locally share the received segments of data by using one or more secondary network interfaces; and
reconstructing a data stream from the segments of data received directly from the data streaming service and from the segments of data received from other devices in the group.

2. The method of claim 1, further comprising:
requesting, by a first device in the group, a batch comprising one or more of the segments of data;
announcing, by the first device to the other devices in the group, an intent to download the batch;
downloading, by the first device, the batch from the data streaming service and avoiding downloading data already advertised by another device; and
one of pushing, by the first device, the batch to the other devices or retrieving the batch from the other devices upon playback.

3. The method of claim 1, further comprising:
assigning, by a first device in the group, which segments of data each device of a group should download based on download rate and connectivity rates of each device;
wherein a device is assigned up to K segments and is assigned more segments only when it finished downloading some of the previously assigned segments; and
wherein if a device fails to download its assigned segment after a predefined period of time, the segment is assigned to another device; and
downloading, by the all devices in the group, the segments that were assigned by the first device.

4. The method of claim 1, further comprising:
pushing, by a downloading device, linear combinations of packets of downloaded segments by multicasting to the other devices of the group;
advertising, by a device, the segments that the device has downloaded and stored locally to the other devices of the group;
requesting, by at least one of the other devices, segments that the at least one of the other devices does not have based on said advertising, wherein said requesting includes an indication of dimensions needed by it to decode the requested segments; and
transmitting linear combinations of packets of a segment of the requested segments to at least one of the other devices, wherein the number of linear combinations is the maximum of dimensions requested for the same segment by other devices.

5. The method of claim 1, further comprising:
enabling overhearing on the devices in the group placing the devices in the group;
filtering overheard packets;
electing a first device of the group as an access point (AP);
transmitting, by another device in the group, a unicast transmission to the AP, wherein the AP does not forward the message; and
overhearing, by all other devices in the group, the unicast transmission.

6. The method of claim 1, wherein the devices are mobile devices.

7. The method of claim 1, wherein said secondary network interface being one of a WiFi or Bluetooth interface.

8. The method of claim 1, wherein the data is consumed simultaneously by all of the devices of the group.

9. A device for cooperative data streaming, comprising a computer readable medium comprising instructions executable to perform:
a first software module configured for initiating a download of data from a data streaming service and deciding which segments of the data each device of a group should download from the data streaming service based on download rate and connectivity rates of each device; and
a second software module configured for distributing segments to the devices of the group by using a local wireless network directly connecting the devices.

10. The device of claim 9, comprising further instructions to perform:
requesting a batch comprising one or more of the segments of data;
announcing to the other devices in the group an intent to download the batch;
downloading the batch from the data streaming service and avoiding downloading data already advertised by another device; and
one of pushing the batch to the other devices or retrieving the batch from the other devices upon playback.

11. The device of claim 9, comprising further instructions to perform:
assigning, by a first device in the group, which segments of data each device of a group should download based on download rate and connectivity rates of each device;
wherein a device is assigned up to K segments, and is assigned more segments only when it finished downloading some of the previously assigned segments; and
wherein if a device fails to download its assigned segment after a predefined period of time, the segment is assigned to another device; and
downloading, by the all devices in the group, the segments that were assigned by the first device.

12. The device of claim 9, comprising further instructions to perform:
pushing, by a downloading device, linear combinations of packets of downloaded segments by multicasting to the other devices of the group;
advertising, by a device, segments that a device has downloaded and stored locally to the other devices of the group;
requesting, by at least one of the other devices, segments that the at least one of the other devices does not have stored locally based on said advertising, wherein said requesting includes an indication of dimensions needed by it to decode the requested segments; and
transmitting linear combinations of packets of a segment of the requested segments to at least one of the other devices, wherein the number of linear combinations is the maximum of dimensions requested for the same segment by other devices

13. The device of claim 9, comprising further instructions to perform:
acting as an access point (AP) for the group; and
receiving, from another device in the group, a unicast transmission to the AP;
wherein all other devices in the group overhear the unicast transmission; and
wherein the unicast transmission is not forwarded.

14. A system for cooperative data streaming, comprising:
a group of devices comprising at least two devices, each device comprising
one or more primary network interfaces connecting the device to the data streaming service;
one or more secondary network interfaces connecting the device to one or more of the other devices through one or more wireless local networks;
wherein said primary network interfaces are configured for connecting at least some of said devices to the data streaming service for receiving at least segments of data in stream mode from said data streaming service;
wherein said secondary network interfaces are configured for mutually connecting said devices in order to locally exchange said received segments of data;
at least some of said devices including a module for reconstructing a data stream from segments of data received directly from the data streaming service and from segments of data received from other devices in the group.

15. The system of claim 14, wherein each device is configured for:
requesting a batch comprising one or more of the segments of data;
announcing to the other devices in the group an intent to download the batch;
downloading the batch from the data streaming service and avoiding downloading data already advertised by another device; and
one of pushing the batch to the other devices or retrieving the batch from the other devices upon playback.

16. The system of claim 14, wherein each device is configured for:
assigning, by a first device in the group, which segments of data each device of a group should download based on download rate and connectivity rates of each device;
wherein a device is assigned up to K segments and is assigned more segments only when it finished downloading some of the previously assigned segments; and
wherein if a device fails to download its assigned segment after a predefined period of time, the segment is assigned to another device; and
downloading, by the all devices in the group, the segments that were assigned by the first device.

17. The system of claim 14, wherein each device is configured for:
pushing, by a downloading device, linear combinations of packets of downloaded segments by multicasting to the other devices of the group;
advertising, by a device, segments that the device has downloaded and stored locally to the other devices of the group; and
requesting, by at least one of the other devices, segments that the at least one of the other devices does not have stored locally based on said advertising, wherein said requesting includes an indication of dimensions needed by the at least one of the other devices to decode the requested segments; and
transmitting linear combinations of packets of a segment of the requested segments to the at least one of the other devices, wherein the number of linear combinations is the maximum of dimensions requested for the same segment by other devices.

18. The system of claim 14, wherein each device is configured for:
acting as an access point (AP) for the group; and
receiving, from another device in the group, a unicast transmission to the AP;
wherein all other devices in the group overhear the unicast transmission; and
wherein the unicast transmission is not forwarded.

19. The system of claim 14, wherein the data is consumed simultaneously by all of the devices of the group.

20. The system of claim 14, wherein the devices are mobile devices.
